(19) United States
(12) Patent Application Publication
(10) Pub. No.: US 2009/0186112 A1
(43) Pub. Date: Jul. 23, 2009

(54) DEVICE FOR CONDITIONING A GLUE-BASED PRODUCT

(75) Inventor: Gérard Maingueneau, Chateau D'Olonne (FR)

Correspondence Address: YOUNG & THOMPSON, 209 Madison Street, Suite 500, ALEXANDRIA, VA, 22314, US

(73) Assignee: J.P.B. CREATIONS, OLONNE SUR MER (FR)

(21) Appl. No.: 12/306,146

(22) PCT Filed: Jun. 21, 2007
(86) PCT No.: PCT/FR07/51487

§ 371 Date: Dec. 22, 2008

(30) Foreign Application Priority Data
Jun. 22, 2006 (FR) 06 52600

(51) Int. Cl. B29B 9/00

(52) U.S. Cl. 425/10

(57) ABSTRACT

The object of the invention is a device for conditioning a thermosetting product, especially a “non-tacky” thermosetting glue comprising an intake (16) of the product to be conditioned in the liquid or pasty state discharging into a tank (26) containing a cooling liquid, the product to be conditioned having a density that is less than or equal to the cooling liquid, characterized in that the intake (16) is located in the lower part of the tank, essentially in the central part, and has shapes allowing the product to be conditioned to be discharged in the form of a lump (32) in an essentially vertical direction upward.

This invention relates to a device for conditioning a glue-based product, and more especially a thermosetting, non-“tacky” glue.

Certain glues such as glues of the “hot melt” type are generally solid at ambient temperature and must be heated to be activated or worked. Among these glues, there are two families of glue, i.e., so-called “tacky” glues that adhere to a surface at ambient temperature, and so-called “non-tacky” glues that do not.

With regard to so-called “tacky” glues, a conditioning process consists in heating the glue and placing it in an envelope using a co-extrusion technique. Thus, the liquid or pasty glue and the material that can form the envelope pass through a nozzle, the material of the envelope surrounding the glue, to form a lump surrounded by an envelope as it emerges. The lump is discharged from the nozzle in an essentially horizontal direction.

As it leaves the nozzle, the lump is immersed in a cooling liquid, especially water. Before the lump has completely solidified, it traverses sectioning means to be formed into lozenges. Consequently, the lump or the lozenges are kept immersed until completely cooled and until all the material becomes solid. To the degree in which the glue is surrounded by an envelope made of a material chosen to solidify quickly, even if the glue does not solidify quickly, the latter is protected during its cooling phase by the envelope so well that the risks of alteration of the glue are limited.

Between the nozzle and the sectioning means, there are generally rollers or the like to guide the lump.

This conditioning technique makes it possible to obtain relatively large lozenges, for example roughly 5 cm or more long and 2 to 3 cm or more wide.

With regard to “non-tacky” glues, the latter are conditioned without an external envelope to the degree in which they are “non-tacky”; this likewise makes it possible to reduce costs.

Since the glue is not protected, the solidification time must be short. Also, “non-tacky” glues are conditioned into the shape of small beads, for example with a cross-section of roughly 1 cm² and a thickness of a few millimeters.

According to a first technique, the liquid or pasty glue is arranged in the form of beads on a conveyor on which it is cooled. Preferably, the lower surface of the conveyor is cooled, for example by contact with or atomization of a cooling liquid in order to reduce the cooling time of the glue. Upon leaving a conveyor with a length of several meters, the glue beads are solid and can be collected into packets.

According to another technique, the liquid or pasty glue travels through one or more openings so as to form one or more strings that are divided into sections at the output by a rotating knife that scrapes the surface at the level of which the openings discharge. The outlet of the opening or openings discharges into a tub containing a cooling liquid, especially water, in the essentially horizontal direction.

To obtain rapid cooling so that the glue is not altered, the strings have reduced diameters and are cut into the form of beads of small dimensions.

Even if these conditioning techniques are satisfactory, conditioning in small beads can cause problems later, especially due to the fact that these beads can be easily lost and can be mixed accidentally with other products, especially food products.

This invention is also intended to remedy these defects of the prior art by suggesting a device for conditioning a thermosetting material, suited for so-called “non-tacky” glues, allowing the conditioning of the material in the form of a volume of significant dimensions without the material being altered.

For this purpose, the object of the invention is a device for conditioning a thermosetting product, especially a “non-tacky” thermosetting glue, comprising an intake of the product to be conditioned in the liquid or pasty state discharging into a tank containing a cooling liquid, the product to be conditioned having a density that is less than or equal to the cooling liquid, characterized in that the intake is located in the lower part of the tank, essentially in the central part, and has shapes allowing the product to be conditioned to be discharged in the form of a lump in an essentially vertical direction upward.

Advantageously, the device comprises at least one cooling liquid intake located in the vicinity of the intake of the product to be conditioned, of which the shapes are suited for discharging the cooling liquid in the direction parallel to the direction of discharge of the product to be conditioned.

The device of the invention makes it possible to increase the running speed of the lump and to obtain a significant flow of cooling liquid for obtaining rapid solidification of the product and for avoiding the risks of alterations. Thus, it is possible to obtain products of significant size.

Other characteristics and advantages will become apparent from the following description of the invention given by way of example alone, with regard to the attached drawings in which:

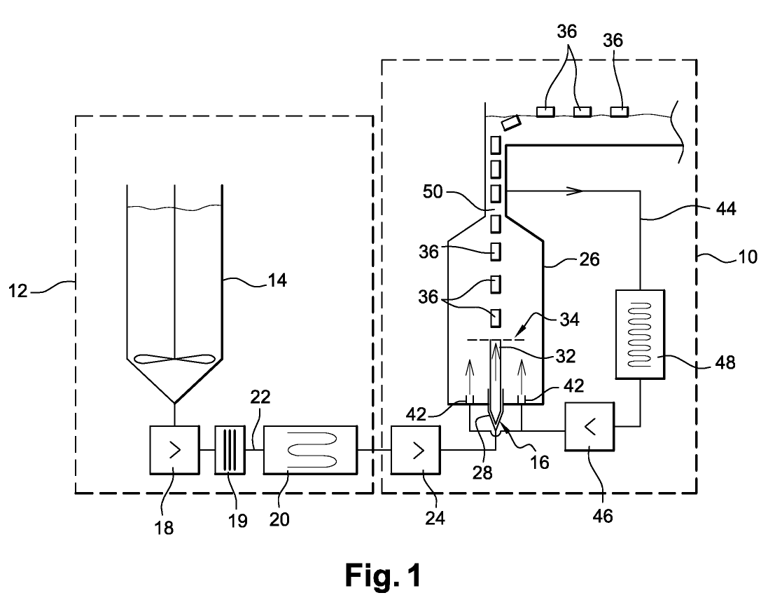

FIG. 1 is a schematic of a conditioning chain integrating a conditioning device according to the invention, and

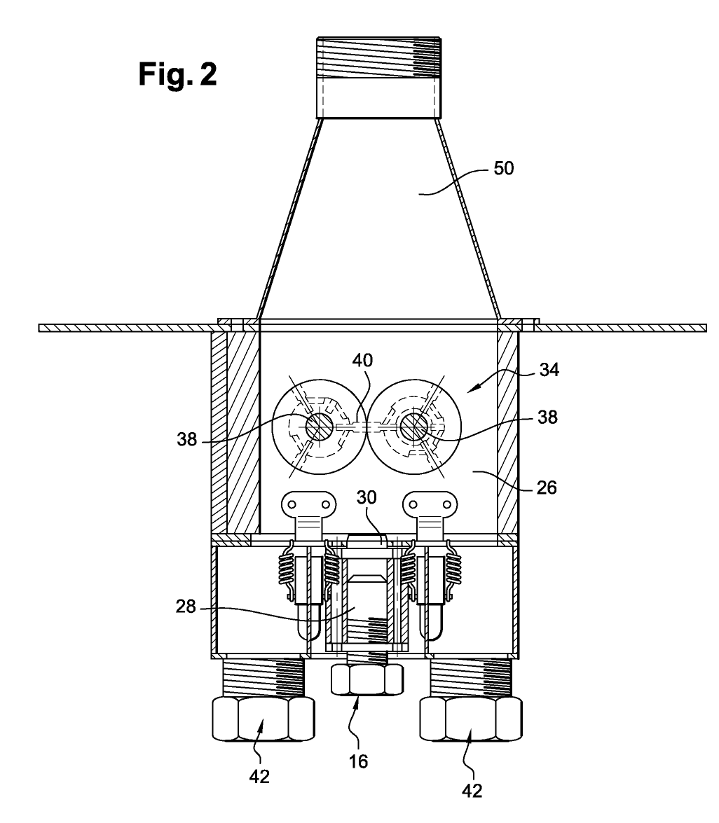

FIG. 2 is a cutaway illustrating in details a conditioning device according to one embodiment.

The device of the invention is more especially suited to “non-tacky” thermosetting products, especially “non-tacky” glues. However, it can be used for the conditioning of “tacky” products, especially “tacky” glues that are placed in envelopes, even if for this type of product, the cooling rate of the product is not critical.

The product conditioned according to the invention is solid at ambient temperature and must be heated to be activated in the case of a glue, or must be worked in the liquid or pasty state.

Hereinafter, the product is defined as a single product or a mixture of products.

In FIG. 1, a conditioning device labeled 10 is arranged, according to the illustrated example, in the extension of a station 12 for production or working of the product to be conditioned.

According to one embodiment, the production station 12 comprises a mixer 14 in which the components of the product to be conditioned are mixed. This mixer 14 preferably includes heating means for keeping the product liquid or pasty at the working temperature. As a rough guide, the product emerges from the mixer 14 at a temperature of between 100 and 180° C.

However, other technical approaches could be envisioned for the production station 12.

The conditioning device 10 comprises at least one intake 16 of the product to be conditioned in the liquid or pasty state.

This intake 16 is connected to the production station 12. At least one pump 18 and, if necessary, one filter 19, and a heat exchanger 20 can be provided at the level of the conduit 22 connecting the production station 12 and the conditioning device 10 for inducing flow, filtering and keeping the product to be conditioned to a temperature allowing it to flow, respectively. Advantageously, flow rate control means 24 are provided upstream and in the vicinity of the intake 16, for example a displacement pump for controlling the flow rate of the product to be conditioned.

The conditioning device 10 comprises a tank 26 containing a cooling liquid, especially water, in which the intake 16 of the product to be conditioned discharges.

In a known manner, the intake 16 has a suitable cross-section, depending on the desired form of the product in the solid state.

According to a preferred embodiment illustrated in FIG. 2, the intake 16 can comprise at least one die 28 through which the product to be conditioned travels, of which one end 30 discharges into the tank 26.

The die as well as the means supporting its connection to the conditioning device are not presented in detail below because they are known to one skilled in the art. Conversely, the intake 16 can comprise a die allowing simultaneous discharge of the product to be conditioned and an envelope around it, especially by co-extrusion. This approach is more especially suited for “tacky” glues.

The invention is more especially intended for products to be conditioned with a density that is less than or equal to the cooling liquid, for example water, which are able to float.

According to the invention, the intake 16 is located in the lower part of the tank, essentially in the central part, and has shapes allowing discharge of the product to be conditioned in the form of a lump 32 in the essentially vertical direction upward. This arrangement makes it possible to exploit the natural movement upward of the product to be conditioned to accelerate the discharge speed; this contributes to obtaining a conditioned product with a considerable volume.

Moreover, according to another advantage, since the temperature gradient of the cooling liquid is vertical, the points on the side wall of the lump 32 at the same height are subjected to essentially identical temperatures. This configuration makes it possible to obtain a uniform temperature around the lump 32; this contributes to limiting the advent of stresses within the product to be conditioned during the solidification phase and to avoid friction at the outlet of the die.

Preferably the conditioning device, vertically to the intake 16, comprises means 34 for cutting the lump 32 so as to divide it into sections to form lozenges 36 or means for precutting at the level of the lump for defining the lozenges.

To the degree to which the direction of discharge of the product is vertical, the conditioning device does not require any means of guiding the lump, in contrast to the prior art.

Moreover, this configuration makes it possible to facilitate set-up of production. Actually, according to the prior art, it is necessary to manually guide the lump to orient it toward the cutting or precutting means; this can entail bum marks. According to the invention, taking into account the orientation of the discharge, guidance in the direction of the means 34 is obtained automatically and naturally.

According to one embodiment, the means 34 comprise two rollers 38, located on both sides of the lump 32, able to pivot around axes perpendicular to said lump, of which the peripheral shapes are suited for cutting or precutting the lump. According to the illustrated example, the rollers 38 comprise blades 40 that can work to cut or precut the lump.

The means 34 are not presented in detail below since they are known to one skilled in the art.

According to another characteristic of the invention, the conditioning device comprises at least one intake 42 of cooling liquid located in the vicinity of the intake 16 of the product to be conditioned, of which the shapes are suited for discharge of the cooling liquid in a direction parallel to the discharge direction of the product to be conditioned, i.e., vertically upward. This arrangement makes it possible, on the one hand, to obtain a Venturi effect that tends to accelerate the speed of advance of the lump, and, on the other hand, to accelerate cooling of the product to be conditioned while enhancing heat exchange.

Advantageously, the device comprises several cooling liquid intakes 42 located symmetrically relative to the intake 16 of the product to be conditioned.

As a rough guide, the flow rate of the product to be conditioned is roughly 500 kg/h and that of the cooling liquid is from 25 to 30 m³/h.

According to one embodiment, the device comprises a cooling liquid recirculation circuit 44 incorporating a pump 46 for controlling the flow rate and, if necessary, an exchanger 48 for keeping the cooling liquid at a proper temperature.

According to another characteristic, the tank 26 directly below the intake 16 of the product to be conditioned comprises a discharge 50 of the conditioned product in the form of lozenges and the cooling liquid. Preferably, the discharge 50 has the shape of a funnel or a nozzle so as to increase the flow rate of the product and the liquid at the level of the discharge; by aspiration, this tends to increase the speed of advance of the lump.

Increasing the speed of advance of the lump and the significant flow of cooling liquid make it possible to obtain rapid solidification of the product and to avoid risks of alterations. Thus, it is possible to obtain products of significant dimensions.

At the outlet of the tank, the lozenges of product can be conveyed by any suitable means.

Of course, the invention is obviously not limited to the embodiment shown and described above, but in contrast encompasses all variants, especially with respect to the nature of the product to be conditioned and of the cooling liquid, the forms of the conditioned product, the dimensions, the forms, and the materials of different elements of the conditioning device.

1. Device for conditioning a thermosetting product, especially a “non-tacky” thermosetting glue comprising an intake (16) of the product to be conditioned in the liquid or pasty state discharging into a tank (26) containing a cooling liquid, the product to be conditioned having a density that is less than or equal to the cooling liquid, characterized in that the intake (16) is located in the lower part of the tank, essentially in the central part, and has shapes allowing the product to be conditioned to be discharged in the form of a lump (32) in an essentially vertical direction upward.

2. Device for conditioning a thermosetting product according to claim 1, wherein it comprises at least one cooling liquid intake (42) located in the vicinity of the intake (16) of the product to be conditioned, of which the shapes are suited for discharge of the cooling liquid in a direction parallel to the direction of discharge of the product to be conditioned.

3. Device for conditioning a thermosetting product according to claim 2, wherein it comprises several cooling liquid intakes (42) located symmetrically relative to the intake (16) of the product to be conditioned.

4. Device for conditioning a thermosetting product according to claim 2, wherein it comprises a cooling liquid recirculation circuit (44).

5. Device for conditioning a thermosetting product according to claim 1, wherein directly below the intake (16) of the product to be conditioned, it comprises a discharge (50) of the conditioned product in the form of lozenges and the cooling liquid.

6. Device for conditioning a thermosetting product according to claim 5, wherein the discharge (50) has the shape of a funnel or a nozzle.

7. Device for conditioning a thermosetting product according to claim 1, wherein vertically to the intake (16), it comprises means (34) for cutting the lump (32) by dividing it into sections to form lozenges (36) or means for precutting at the level of the lump for defining lozenges.

8. Device for conditioning a thermosetting product according to claim 3, wherein it comprises a cooling liquid recirculation circuit (44).

9. Device for conditioning a thermosetting product according to claim 2, wherein directly below the intake (16) of the product to be conditioned, it comprises a discharge (50) of the conditioned product in the form of lozenges and the cooling liquid.

10. Device for conditioning a thermosetting product according to claim 3, wherein directly below the intake (16) of the product to be conditioned, it comprises a discharge (50) of the conditioned product in the form of lozenges and the cooling liquid.

11. Device for conditioning a thermosetting product according to claim 4, wherein directly below the intake (16) of the product to be conditioned, it comprises a discharge (50) of the conditioned product in the form of lozenges and the cooling liquid.

12. Device for conditioning a thermosetting product according to claim 2, wherein vertically to the intake (16), it comprises means (34) for cutting the lump (32) by dividing it into sections to form lozenges (36) or means for precutting at the level of the lump for defining lozenges.

13. Device for conditioning a thermosetting product according to claim 3, wherein vertically to the intake (16), it comprises means (34) for cutting the lump (32) by dividing it into sections to form lozenges (36) or means for precutting at the level of the lump for defining lozenges.

14. Device for conditioning a thermosetting product according to claim 4, wherein vertically to the intake (16), it comprises means (34) for cutting the lump (32) by dividing it into sections to form lozenges (36) or means for precutting at the level of the lump for defining lozenges.

15. Device for conditioning a thermosetting product according to claim 5, wherein vertically to the intake (16), it comprises means (34) for cutting the lump (32) by dividing it into sections to form lozenges (36) or means for precutting at the level of the lump for defining lozenges.

16. Device for conditioning a thermosetting product according to claim 6, wherein vertically to the intake (16), it comprises means (34) for cutting the lump (32) by dividing it into sections to form lozenges (36) or means for precutting at the level of the lump for defining lozenges.
